(19) United States
(12) Patent Application Publication
(10) Pub. No.: US 2007/0210698 A1
(43) Pub. Date: Sep. 13, 2007

(54) IMAGE DISPLAY APPARATUS AND METHOD OF MANUFACTURING THE SAME

(76) Inventors: Hajime Tanaka, Hiratsuka-shi (JP); Takeo Ito, Kumagaya-shi (JP); Yasunori Gamo, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/689,159

(22) Filed: Mar. 21, 2007

Related U.S. Application Data
(63) Continuation of application No. PCT/JP05/17636, filed on Sep. 26, 2005.

(30) Foreign Application Priority Data
Sep. 27, 2004 (JP) 2004-280073

(51) Int. Cl. H01J 1/62

(52) U.S. Cl. 313/496

(57) ABSTRACT

The invention provides an image display apparatus with high productivity, which can control a peak of a discharge current even if an electric discharge occurs between an electron beam source and a fluorescent surface, and a method of manufacturing the apparatus. An image display apparatus has a metal back layer which is made electrically discontinuous by an unevenness formed by exposure of a shape of a fluorescent particle of a fluorescent substance layer, or by elimination of the smoothing layer, and a fluorescent surface with a fluorescent substance layer arranged in a specified order.

### CROSS-REFERENCE TO RELATED APPLICATIONS

This is a Continuation Application of PCT Application No. PCT/JP2005/017636, filed Sep. 26, 2005, which was published under PCT Article 21(2) in Japanese.

This application is based upon and claims the benefit of priority from prior Japanese Patent Application No. 2004-280073, filed Sep. 27, 2004, the entire contents of which are incorporated herein by reference.

### BACKGROUND OF THE INVENTION

1. Field of the Invention

The present invention relates to an image display apparatus, and a method of manufacturing the same. More particularly, the invention relates to an image display apparatus which has an electron source and a fluorescent surface to display an image by emitting an electron beam, in a vacuum housing, and a method of manufacturing the image display apparatus.

2. Description of the Related Art

A cathode-ray tube (CRT), which is widely used as an image display apparatus, emits an electron beam to fluorescent elements to light the fluorescent elements, and displays an image as a result.

In recent years, there has been developed an image display apparatus provided with many electron-emitting elements (electron source) which selectively emit electron beams to a flat fluorescent screen arranged in a plane and opposed across a predetermined interval, and outputs fluorescence (displays an image). This (plane type) image display apparatus is called a field emission display (FED). In an FED, a display apparatus using a surface transmission emitter as an electron source is classified as a surface transmission type electron emission display (SED). In this application, the term FED is used as a generic name including an SED.

A field emission display (FED) can be made by setting a clearance between an electron source substrate and a fluorescent surface substrate to several millimeters or less. Therefore, an FED can be made thinner than a well-known CRT, and equivalent to or thinner than a flat display unit like an LCD. An FED can be made light in weight. An FED is a self-emission type like a CRT and a plasma display, and displays an image with high brightness.

In an FED, the light of image output from a fluorescent substance is reflected to a display surface, or a visual surface for an observer, or a faceplate to increase luminance of an image. For this purpose, a metal back layer, or a metal layer to reflect a light beam advancing to an electron source among those output from a fluorescent substance by an electron emitted from an electron source, is provided on a fluorescent surface including a fluorescent substance layer. A metal back layer functions as an anode (positive pole) for an electron source, or an emitter.

Further, in an FED, the substrates of electron source and fluorescent surface are opposed with a clearance of several millimeters or less, and the degree of vacuum is held at approximately 10⁻⁴ Pa. It is thus well known that if an internal pressure is increased by gas generated inside, the amount of electron emitted from an electron source is decreased, and the luminance of an image is decreased. Therefore, it is proposed to provide a getter material to absorb the gas generated inside, at a desired position except a fluorescent surface or an image display area.

It is also known that in the construction of an FED, there is a clearance of several millimeters or less between a faceplate and a rear plate in an electron source having an electron-emitting element, and when a high voltage of approximately 10 kV is applied to the clearance between the two plates, a vacuum arc discharge generating a large discharge current reaching 100A is likely to occur between a metal back layer as an anode and an emitter as an electron source.

Jpn. Pat. Appln. KOKAI Publication No. 10-326583 proposes a method of securing a high anode voltage by dividing a metal back layer into a plurality of parts, and connecting to an anode power supply as a common electrode through a resistor member.

Jpn. Pat. Appln. KOKAI Publication No. 2000-311642 discloses a technique to increase an effective impedance of a fluorescent surface by forming a zigzag pattern of notches on a metal back layer.

The above patent documents report that generation of an electric discharge can be prevented by dividing a metal back layer functioning as an anode into an optional number of parts. However, actually, it is difficult to completely prevent generation of an electric discharge, owing to an interval between a phase plate and a rear panel varies, largeness of voltage applied to an anode, and changes over time. Namely, damages of an electron-emitting element or a fluorescent surface, and deterioration of display image quality caused by changes in characteristics, are not sufficiently improved at the present time.

A largeness of a discharge current at occurrence of an electric discharge is prevented to a certain extent, but as of now, it is unavoidable problem that a discharge current larger than a value not to affect display of image flows. It is also proposed to divide an anode and divide a getter layer, but an electric discharge is not completely eliminated.

### BRIEF SUMMARY OF THE INVENTION

It is an object of the present invention to provide an image display apparatus with high quality display image, which can decrease the largeness of discharge current even when an electric discharge occurs between an electron source and a fluorescent surface, and a method of manufacturing the image display apparatus.

This invention is provided an image display apparatus provided with at least a light-shielding layer to shield light, a screen including a fluorescent substance, and a metal back as a metal layer for reflection between airtight glass base materials:

wherein the light-shielding layer includes a light shielding area to prevent leakage of light from an adjacent fluorescent substance in a part around a display area where a fluorescent substance forming the screen tightly contact the glass base material, and

the metal back is selectively provided only in an area corresponding to the back of the display area, through a smoothing member.

Also, this invention is provided an image display apparatus, comprising a front substrate having a fluorescent surface layer including a fluorescent substance layer and a light-shielding layer, and a vacuum formed conductive thin film laid over the fluorescent surface layer; and a rear substrate arranged opposite to the front substrate and provided with an electron-emitting element to emit an electron to the fluorescent surface,

wherein the conductive thin film is selectively provided in an area over the light-shielding layer through a discontinuous thin film.

Further, this invention is provided a method of manufacturing an image display apparatus comprising a front substrate having a fluorescent surface layer including a fluorescent substance layer and a light-shielding layer, and a vacuum formed conductive thin film laid over the fluorescent surface layer; and a rear substrate arranged opposite to the front substrate and provided with an electron-emitting element to emit an electron to the fluorescent surface,

wherein a fluorescent substance layer, a light-shielding layer to partition a fluorescent substance layer, and a smoothing layer to uniformly cover the whole surface of a fluorescent surface layer are formed on the front substrate,

a part of a smoothing layer overlapping a light-shielding layer is selectively eliminated, and

a conductive metal film is formed in the same process for each of a smoothing layer formed on the front substrate and a part where a smoothing layer is selectively eliminated, thereby collectively forming a conductive thin film including a discontinuous thin film provided in an area overlapping the light.

### BRIEF DESCRIPTION OF THE SEVERAL VIEWS OF THE DRAWING

FIG. 1 is a perspective view of a flat image display apparatus, an FED, according to an embodiment of the invention;

FIG. 2 is a sectional view of the FED taken along lines I-I of FIG. 1;

FIG. 3 is a plan view of a fluorescent surface and a metal back layer in the FED shown in FIG. 2;

FIG. 4 is a magnified plan view of a fluorescent surface and a light-shielding layer of the FED shown in FIG. 2;

FIG. 5 is a sectional view of a fluorescent surface taken along lines II-II of FIG. 4; and

FIG. 6 is a sectional view of a fluorescent surface take along lines III-III of FIG. 4.

### DETAILED DESCRIPTION OF THE INVENTION

Hereinafter, embodiments of the invention will be explained in detail with reference to the accompanying drawings.

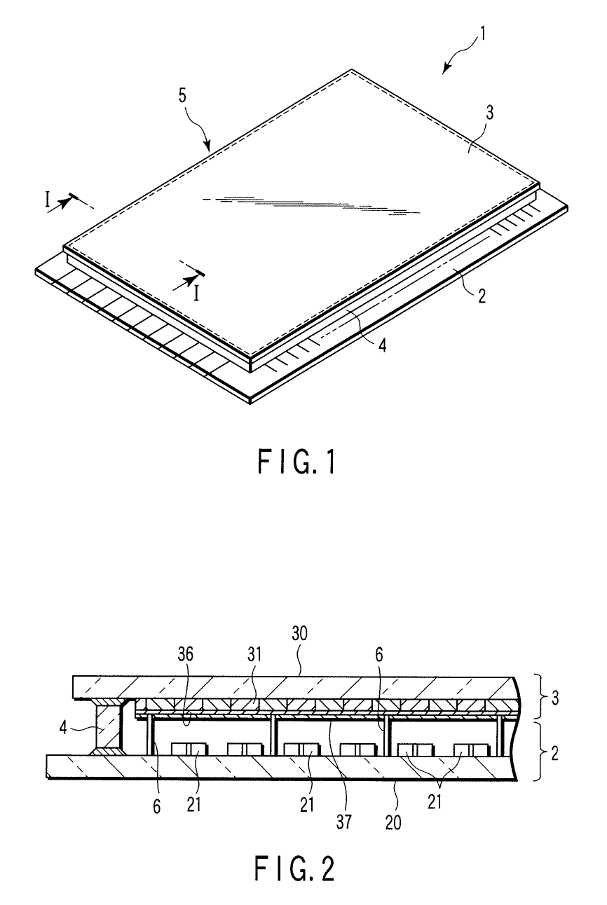

FIG. 1 and FIG. 2 show the structure of a flat image display apparatus, field emission display (FED), according to an embodiment of the invention.

An image display apparatus FED 1 has an electron source substrate 2 having a plurality of electron-emitting elements as an electron source on a plane (a first substrate, hereinafter called a rear panel), and a fluorescent surface substrate 3 (a second substrate, hereinafter called a faceplate) opposed to the rear panel 2 at predetermined intervals and formed with a plurality of fluorescent substances like sections which emits a fluorescent light when receiving an electron beam.

The rear panel 2 and faceplate 3 include a glass base material 20 that is a rectangular rear side namely an electron source, and a glass base material 30 that is a front side namely a fluorescent surface, each of which is formed rectangular and given predetermined area. In the main area as a display area of the base materials 20 and 30, predetermined numbers of electron sources and fluorescent substance are provided as explained later in FIG. 2.

The glass base materials 20 and 30 of the rear panel 2 and faceplate 3 are opposed at intervals of 1-2 mm, and joined by a side wall 4 provided at the peripheral edge portion as shown in FIG. 2. Namely, the FED 1 is made as an airtight outer enclosure 5 by the rear panel 2, faceplate 3, and side wall 4. The inside of the outer enclosure 5 is held in a vacuum of approximately 10⁻⁴ Ps. Between the glass base materials of the rear panel and faceplate 3, a number of plate-like or column-like spacers 6 is arranged in order to resist atmospheric pressure acting on each glass material in the state assembled as an outer enclosure 5.

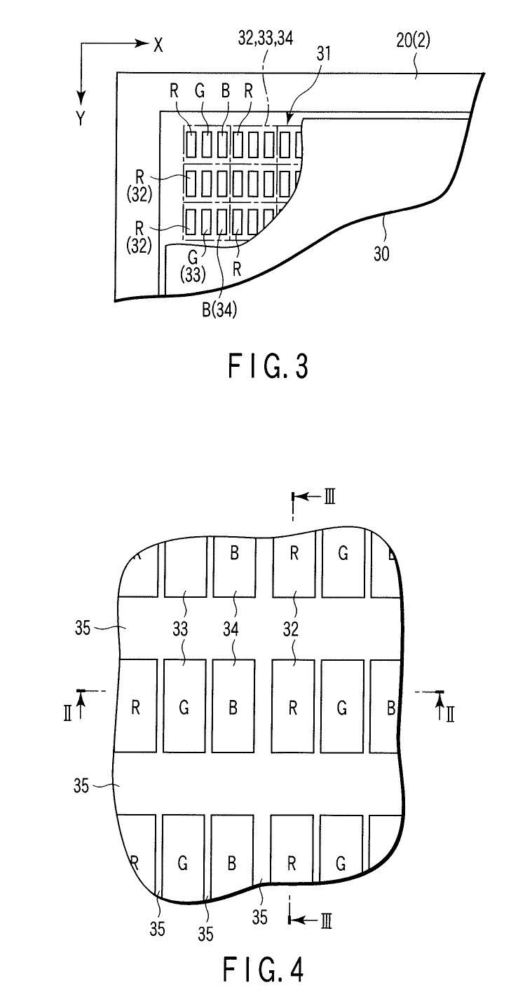

A fluorescent surface 31 is formed on one side of the glass material 30 used as a faceplate 3, or the surface facing the inside when assembled as an outer enclosure 5. As described later in FIG. 3 and FIG. 4, the fluorescent surface 31 includes the fluorescent substance layers 32 (R), 33 (G) and 34 (B) on which three kinds of fluorescent substance to emit red (R), green (G) and blue (B) lights are arranged in predetermined order and area, and a light-shielding layer 35 which is arranged like a matrix dividing the fluorescent substance layers. Each of the fluorescent substance layer 32 (R), 33 (G) and 34 (B) is formed like a stripe extending in one direction, or as a dot. The light-shielding layer 35 is also called a black mask.

On one side of the glass base material 20 used as a rear panel 2, or the surface facing the inside when assembled as an outer enclosure 5, a plurality of electron-emitting elements (emitters) 21 to selectively emit an electron beam is provided to excite the fluorescent substance layers 32, 33 and 34 formed on the fluorescent surface 31 of the faceplate 3. The emitter 21 is arranged in 800 rows ×3 and 600 columns corresponding to each pixel as one unit formed by fluorescent substance layers R, G and B formed on the faceplate 3. The emitter 21 is driven through a matrix wiring connected to a not-shown scanning line driving circuit and signal line driving circuit.

Assuming the longitudinal direction of the faceplate 3 as a first direction or an X-direction and the width direction orthogonal to the X-direction as a second direction or a Y-direction, each of the fluorescent substance layers 32(R), 33(G) and 34(B) is formed like a stripe extending in the Y-direction. The fluorescent substance layers 32(R), 33(G) and 34(B) are arranged by taking three colors as one unit.

The light-shielding layer 35 is a mixture of carbon and binder, for example, with electrical insulation. The binder content is defined to a maximum of 80%.

The light-shielding layer 35 is arranged in the first X direction with a predetermined gap (interval) by taking three colors as one unit to be divided into 800 lines, for example. The light-shielding layer 35 is also provided in a predetermined width (interval) between the fluorescent substance layers of each color, that is, between R and G and between G and B. The light-shielding layer 35 is arranged in 600 lines in the second Y direction. In other words, the fluorescent substance layers R/G/B as a pair of three colors are arranged in a predetermine order inside the sections defined by each line of the light-shielding layer 35, or in a window (35a) where the light-shielding layer 35 does not exist.

On the whole surface of the fluorescent surface 31 covering the fluorescent substance layers (32, 33, 34), a metal back layer 37 functioning as an anode electrode is formed through a smoothing layer 36 that smoothes the fluorescent substance layers 32, 33 and 34 having uneven surfaces. The term “metal back layer” is used in the present invention, but the material of this layer is not limited to a metal. Other various materials may be used, as long as the layer functions as an anode.

The smoothing layer 36 is made of organic resin material or aqua glass, and formed evenly all over the surface of the fluorescent surface 31 by spraying, for example. The smoothing layer 36 is useful to make a surface not contacting a fluorescent substance layer like a mirror, when a metal used as a metal back layer or a material with predetermined conductivity is formed on the fluorescent surface 31 by a vacuum thin film process, for example. Namely, the metal back layer 37 is preferably made as a mirror surface to efficiently reflect the light output from each of the fluorescent substance layers 32, 33 and 34 to the viewing side of the faceplate 3.

The metal back layer 37 is preferably made by evaporating aluminum (Al) to a thickness of 50-200 nm from the viewpoint of electron beam transmissivity and layer strength. The metal back layer 37 is preferably made of aluminum (Al) or titanium (Ti) or metal containing titanium in terms of low density and cost and high electron transmissivity and reflection spectrum uniformity.

As apparent from FIG. 5, before the metal pack layer 37 is formed in the smoothing layer 36, at least an area of the smoothing layer 36 to form the metal back layer 37 on the light-shielding layer 35 is selectively eliminated by cutting by heating by a laser beam or by pressing a plate-like or wire-like heating mechanism by a predetermined pressure. As a method of eliminating the smoothing layer 36, cutting with a knife or cutter, scraping with a needle-like metal, or shaping by a photolithography process is available.

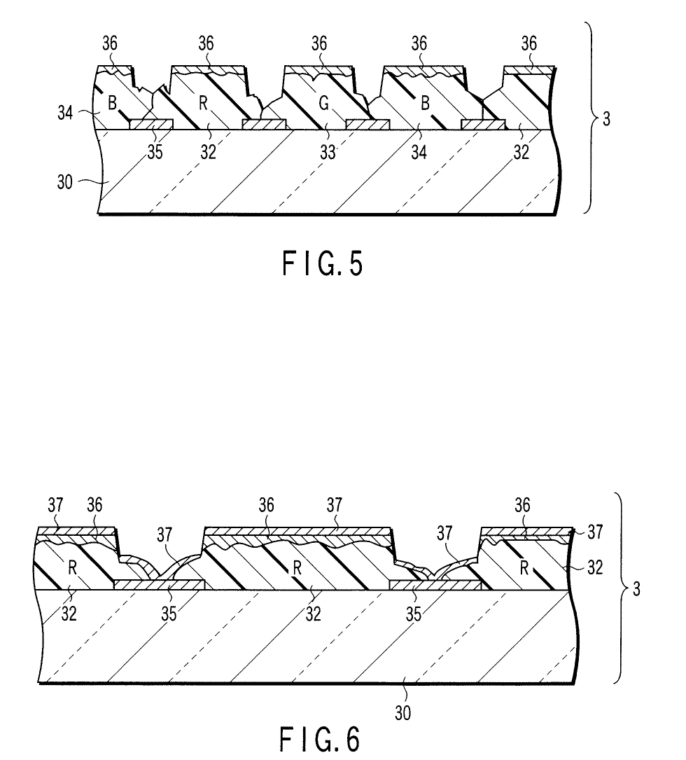

Therefore, as shown in FIG. 6, the metal back layer 37 becomes a mirror surface free from unevenness when placed on the back of the fluorescent substance layers 32, 33 and 34, and becomes discontinuous and uneven at a position corresponding to the light-shielding layer 35 by elimination of the smoothing layer 36 or exposure of the shape of a fluorescent particle used for the fluorescent substance layer.

Namely, the metal back layer 37 is divided like a matrix at a predetermined position except the area to form the fluorescent substance layers 32, 33 and 34. The term “divide” means no electrical continuity, but generally even an insulator does not have an infinite resistance value, and an electrical discontinuity does not occur in a strict sense. Therefore, the expression “electrically divided” in this application means that a resistance is extremely increased in a discontinuous layer compared with a continuous layer.

As the metal back layer 37 is divided, an anode voltage supply system is necessary as a feedback circuit for a current generated by an electron beam from the emitter 21. Therefore, by preparing and connecting a not-shown common electrode given a predetermined resistance value to the anode voltage supply system, a function as an anode electrode can be obtained while securing a function of controlling a discharge current by dividing the metal back layer 37.

In the image display apparatus 1, when an electron beam is radiated from the electron-emitting element 21 in the state that an anode voltage is applied to the metal back layer 37, an electron beam collides with a corresponding fluorescent substance layer and a predetermined light, that is, an image is output.

Namely, an electron beam emitted from the emitter 21 at a position defined by Xn_{(R,G,B)}-Ym (n: row, n: column, (R,G,B): color) specified by not-shown scanning line driving circuit and signal line driving circuit, is accelerated by an anode voltage and collides with any one of the fluorescent substance layers 32, 33 and 34 of a corresponding pixel. As a result, light of an object color is output from a corresponding fluorescent substance layer. Therefore, when a predetermined color light is generated at an optional position for a predetermined time, a color image is displayed on the outside or the viewing side of the glass base material 30 of the faceplate 3.

Next, a brief explanation will be given on an example of a process of manufacturing the above-mentioned fluorescent surface.

First, form a not-shown base processing agent to a predetermined thickness on one side of the glass substrate 30 used for the faceplate 3, and form a predetermined pattern of the light-shielding layer 35 made of black pigment or carbon by photolithography. The light-shielding layer 35 is given a pattern of a vertical line part 35V and a horizontal line part 35H arranged like a matrix.

Then, apply a fluorescent solution of ZnS, Y₂O₃ or Y₃O₂S group to a light-emitting space as a display area partitioned by the vertical line part 35V and horizontal line part 35H, by a slurry method. Dry the applied solution, make patterning by photolithography, and form fluorescent substance layers 32, 33 and 34 of three colors red (R), green (G) and blue (B). A fluorescent substance layer for each color can also be formed by spraying or screen printing. Of course, patterning by photolithography may be used as needed in the spraying or screen printing.

Then, form a not-shown flat smoothing layer made of inorganic material such as aqua glass on the fluorescent surface 31, or the fluorescent substance layers 32, 33 and 33, by spraying. Form a metal back layer 37 made of a metallic film such as aluminum (Al) by vacuum evaporation, CVD or spattering. As explained before, the metal back layer 37 is divided for each display area as sections of fluorescent substance layers 32, 33 and 34 by the uneven surface of the light-shielding layer exposed by the partial elimination of the smoothing layer.

Insert the faceplate 3 provided with the fluorescent surface 31 and the rear plate 2 provided with electron-emitting elements 21 as electron sources into a not-shown vacuum unit, and enclose the faceplate 3 and rear panel 2 in a vacuum with a predetermined decreased pressure. Form a not-shown getter material on the metal back layer 37 if necessary. The getter material formed on the metal back layer 37 decreases a change in the inside pressure or vacuum of the outer enclosure 5 caused by impurity gas generated in the outer enclosure. Therefore, an image display apparatus capable of displaying color images stably for a long time can be obtained.

Then, although not described in detail, the FED 1 is formed by connecting a not-shown power supply system for an anode, a scanning line driving circuit, and a signal line driving circuit.

In the FED configured as described above, the metal back layer 37 as a conductive thin film is electrically discontinuously partitioned by the light-shielding layer 35. In other words, the metal back layer 37 is electrically divided. Therefore, even if an electric discharge occurs between the phase plate 3 and rear panel 1, a peak value of a discharge current can be sufficiently controlled, and a damage caused by a discharge can be avoided.

In the embodiment described above, the surface unevenness of the light-shielding layer 35 is provided in all rows and columns of a matrix. However, the light-shielding layer 35 may be provided only between B and R, and in an area with a wide interval, when R, G and B are collectively taken as one pixel.

Further, by forming the metal back layer 37 on the fluorescent surface 31 including the light-shielding layer 35 with the uneven surface by a vacuum film forming process, the metal back layer 37 including an electrically discontinued area can be collectively formed on substantially the whole surface of the fluorescent surface 31 by one process. Therefore, it possible to manufacture an image display apparatus free from damages by an electric discharge at a low cost.

According to the invention explained hereinbefore, it is possible to provide an image display apparatus which can sufficiently prevent a discharge current and largely decrease damages caused by an electric discharge even if a discharge occurs between the faceplate as a front substrate and a rear panel as a rear substrate. Namely, the metal back layer as a metal layer on the back of the fluorescent substance used to increase luminance of a display image is not formed to have a continuous surface, occurrence of electric discharge is decreased, and an image display apparatus can be operated for a long time.

The invention is not limited to the aforementioned embodiments. Various modifications and variations are possible in a practical stage without departing from its essential characteristics. Each embodiment may be appropriately combined as far as possible. In such a case, the effect by the combination is obtained.

What is claimed is:

1. An image display apparatus provided with at least a light-shielding layer to shield light, a screen including a fluorescent substance, and a metal back as a metal layer for reflection between airtight glass base materials:
wherein the light-shielding layer includes a light shielding area to prevent leakage of light from an adjacent fluorescent substance in a part around a display area where a fluorescent substance forming the screen tightly contact the glass base material, and
the metal back is selectively provided only in an area corresponding to the back of the display area, through a smoothing member.

2. The image display apparatus according to claim 1, wherein the smoothing member is composed of a thin film formed uniformly on the screen, and selectively eliminated in an area corresponding to the light-shielding layer.

3. The image display apparatus according to claim 1, wherein the smoothing member is formed by cutting with a laser beam or a heating mechanism, shaping by photolithography, or cutting with a knife or metal.

4. An image display apparatus, comprising a front substrate having a fluorescent surface layer including a fluorescent substance layer and a light-shielding layer, and a vacuum formed conductive thin film laid over the fluorescent surface layer; and a rear substrate arranged opposite to the front substrate and provided with an electron-emitting element to emit an electron to the fluorescent surface,
wherein the conductive thin film is selectively provided in an area over the light-shielding layer through a discontinuous thin film.

5. A method of manufacturing an image display apparatus comprising a front substrate having a fluorescent surface layer including a fluorescent substance layer and a light-shielding layer, and a vacuum formed conductive thin film laid over the fluorescent surface layer; and a rear substrate arranged opposite to the front substrate and provided with an electron-emitting element to emit an electron to the fluorescent surface,
wherein a fluorescent substance layer, a light-shielding layer to partition a fluorescent substance layer, and a smoothing layer to uniformly cover the whole surface of a fluorescent surface layer are formed on the front substrate,
a part of a smoothing layer overlapping a light-shielding layer is selectively eliminated, and
a conductive metal film is formed in the same process for each of a smoothing layer formed on the front substrate and a part where a smoothing layer is selectively eliminated, thereby collectively forming a conductive thin film including a discontinuous thin film provided in an area overlapping the light.

6. An image display apparatus constructed airtight in which a first substrate holding an electron beam source and a second substrate holding a fluorescent substance layer to output a predetermined color light when an electron beam output from the electron beam source is applied are opposed at a predetermined interval, wherein the fluorescent substance layer having:
a light-shielding layer which is provided in the second substrate, partitions the fluorescent substance for each color output from each fluorescent substance, and prevents a light beam output from an optional fluorescent substance from reaching an adjacent partition;
a light-emitting layer which is provided in a predetermined order in each area partitioned by the light-shielding layer, and composed of a plurality of fluorescent substances capable of outputting a predetermined color light;
a smoothing layer which is provided on the surface of the light-emitting layer except an area corresponding to the light-shielding layer, and smoothes the surface of the light-emitting layer; and
a metal back as a reflection metal layer which is provided on the smoothing layer and light-shielding layer in the same process, and reflects a light beam generated by each fluorescent substance of the light-emitting layer to a viewing side of the second substrate.

7. The image display apparatus according to claim 6, wherein the smoothing layer is composed of a thin film containing resin, and formed in an area corresponding to the light-shielding layer by cutting with a laser beam or a heating mechanism, shaping by photolithography, or cutting with a knife or metal.

8. An image display apparatus comprising:
a first substrate rear panel holding an electron beam source;
a fluorescent substance which is provided on one side of a second substrate arranged opposite to the first substrate at a predetermined interval, and outputs a predetermined color light when an electron beam output from the electron beam source of the first substrate is applied;
a light-shielding layer which partitions the fluorescent substance for each color output from the fluorescent substance on one side of the second substrate, and prevents an output light from the fluorescent substance from reaching an adjacent partition;
a smoothing layer which is provided on the whole surfaces of the fluorescent substance and light-shielding layer, and is selectively and partially eliminated in the light-shielding layer, and smoothes the surface of the light-emitting layer; and
a metal back as a reflection metal layer which is provided on the smoothing layer and light-shielding layer in the same process, and reflects a light beam generated by each fluorescent substance of the light-emitting layer to a viewing side of the second substrate.

9. The image display apparatus according to claim 8, wherein the smoothing layer is composed of a thin film containing resin, and formed in an area corresponding to the light-shielding layer by cutting with a laser beam or a heating mechanism, shaping by photolithography, or cutting with a knife or metal.
